(19) United States
(12) Patent Application Publication
(10) Pub. No.: US 2006/0072377 A1
(43) Pub. Date: Apr. 6, 2006

(54) Domain expansion rom media with adapted domain shape for improved readout

(75) Inventors: Coen Adrianus Verschuren, Eindhoven (NL); Ferry Zijp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/534,472

(22) PCT Filed: Oct. 21, 2003
(86) PCT No.: PCT/IB03/04696

§ 371 Date: May 10, 2005

(30) Foreign Application Priority Data
Nov. 14, 2002 (EP) 02079743.7

(51) Int. Cl. G11B 11/00

(52) U.S. Cl. 369/13.01; 369/13.08

(57) ABSTRACT

The present invention relates to a domain expansion storage medium and manufacturing method with improved readout performance. The substrate of the storage medium and/or its storage layer is processed to define a predetermined shape of magnetic domains, adapted to the front of the thermal reading profile. In particular, reversed crescent shaped domains flipped in the track directions are defined. This allows improved resolution and jitter values.

Domain expansion ROM media with adapted domain shape for improved readout The present invention relates to a domain expansion data storage medium and a manufacturing method for such a medium, in which a magnetic domain in a magnetic data storage layer is copied into a magnetic read out layer after which the domain wall of the copied domain in the read out layer is displaced to thereby enlarge said copied magnetic domain so as to reproduce an information indicated by the magnetic domain in the data storage layer.

In current magneto-optical storage systems, the minimum width of the recorded marks is determined by the diffraction limit, i.e. by the Numerical Aperture (NA) of the focussing lens and the laser wavelength. A reduction of the width is generally based on shorter wavelength lasers and higher NA focussing optics. The capability of writing extremely small domains is essential to increasing a real storage densities in magneto-optical (MO) media. Fortunately, writing is a thermo-magnetic process which is not limited to the spot size of the laser, but rather to the size of the heated area and the frequency of an alternating external magnetic field. Currently, the ability to write small domains far exceeds the ability to read them. Writing is achieved by modulating either the laser power, e.g. in Light Intensity Modulation (LDVI), or the external field, e.g. in Magnetic Field Modulation (MEM), or both, e.g. in Laser Pumped MFM (LP-MFM).

In MFM writing, the external electromagnet is made small enough to switch at the recording data rate, by modulating the external magnetic field with the incoming data while continuous laser irradiation is applied to the media, data can be written to the disc. Write density for MFM is greatly improved over LIM because the domain size is no longer limited by the diffraction limit The recorded domain now takes on a crescent shape due to the shape of the heat contours when the field is switched.

It has been shown that by combining both LIM and MFM, even smaller and better defined marks can be written. This technique is called laser pumped MFM (LP-MFM). The pulsed laser radiation results in a steeper temperature gradient at the writing threshold and thus results in better defined domains. The bit transitions are then determined by the switching of the external field and the temperature gradient induced by the switching of the laser. For readout of the small crescent shaped marks recorded in this way, Magnetic Super Resolution (MSR) or Domain Expansion (DomEx) methods have been proposed. These technologies are based on recording media with several magneto-static or exchange-coupled rare earth—transition metal (RE-TM) layers. According to MSR, a magneto-optical readout layer on a magneto-optical data storage layer is arranged to mask adjacent bits in the storage layer during reading, while with the magnetic domain expansion technique a domain in the storage layer is copied and expanded in the magneto-optical read out layer. The advantage of the domain expansion technique over MSR results in that bits with a length below the diffraction limit can be detected with a similar signal-to-noise ratio (SNR ) as bits with a size comparable to the diffraction limited spot. RF-MAMMOS (Magnetic AMplifying Magneto-Optical System), as described in e.g. Applied Physics Letters 69, nr 27 (1996) 4257-4259 by H. Awano et al., is a domain expansion method based on magneto-statically coupled storage and readout layers, wherein a magnetic field modulation is used for expansion and collapse of expanded domains in the readout layer. A written mark from the storage layer is copied to the readout layer upon laser heating with the help of an external magnetic field. Due to the low coercivity of this readout layer, the copied mark will expand to fill the optical spot and can be detected with a saturated signal level which is independent of the mark size. Reversal of the external magnetic field collapses the expanded domain. A space in the storage layer, on the other hand, will not be copied and no expansion occurs. Therefore, no signal will be detected in this case.

Domain Wall Displacement Detection (DWDD) is another DomEx method based on an exchange-coupled storage and readout layer, proposed by T. Shiratori et al. in Proc. MORIS'97, J. Magn. Soc. Jpn., 1997, Vol. 22, Supplement No. S2, pp. 47-50. In a DWDD medium, marks recorded in the storage layer are transferred to a displacement layer via an intermediate switching layer as a result of exchange coupling forces. The temperature rises when reproducing laser spots are irradiated onto the discs recording tracks. When the switching layer exceeds the Curie temperature, the magnetization is lost, causing the exchange coupling force between each layer to disappear. The exchange coupling force is one of the forces holding the transferred marks in the displacement layer. When it disappears, the domain wall surrounding the recorded marks shifts to a high temperature section which has low domain wall energy, allowing small recorded marks to expaned. The domain wall which had been transferred into the displacement layer shifts as if being pulled by a rubber band. This allows reading via laser beam, even if recordings have been made at a data density larger than the so called diffraction limit, i.e. the optical resolution limit of the readout optics.

Domain expansion techniques such as MAMMOS and DWDD thus allow readout of bits much smaller than the size of the optical spot, but with a signal to noise ratio much larger than in MSR. The various disc stacks always comprise a recording layer and a readout layer, which may be coupled magneto-statically or by means of exchange coupling. RF MAMMOS requires a modulating external magnetic field during readout, which increases the power consumption, but also allows readout at very high densities and with large signal to noise ratios. Alternative techniques like Zero-Field Magnetic AMplifying Magneto-Optical System (ZF MAMMOS) and DWDD require no external magnetic field during readout, but are expected to be limited to somewhat lower densities, smaller signals and lower data rates. The present invention can also be used in combination with these alternative techniques.

In families of optical storage media, the ROM (Read Only Memory) format is seen as an addition used for cheap and fast reproduction of pre-recorded data. These properties of ROM are considered essential for the success of an optical storage product-family. In the case of domain expansion media, a ROM solution is not trivial. The reason is that data is defined by magnetization directions in the storage layer, which are not easily reproduced in pre-recorded media, e.g. by injection moulding.

Documents U.S. Pat. No. 5,993,937 and EP 0848381A2 disclose domain expansion ROM media with a domain expansion stack on an injection moulded substrate with smooth and rough areas to define the recorded information.

In recent publications, such as T. Sakamoto and Y. Tanaka, MORIS 2002 paper Mo-D2, it was demonstrated for different domain expansion techniques that a reverse rotation direction during readout leads to lower jitter and higher resolution and thus improves the readout performance. However, an implementation of such reverse rotation is very impractical in current systems.

It is an object of the present invention to provide a practical solution for a domain expansion ROM medium with improved readout performance.

This object is achieved by a domain expansion storage medium as claimed in claim 1 and a manufacturing method as claimed in claim 5.

Accordingly, by providing magnetic domains with an adapted shape in domain expansion ROM media, the advantages achieved by the reversed rotation direction can be obtained without actually reversing the direction. Thus, small jitter and high density can be obtained in a practical manner without any changes required in the reproduction apparatus or system.

Preferably, the magnetic domain may have a crescent shape reversed with respect to the track direction of the storage medium, wherein the curvature of the concave edge of the crescent shape substantially matches with the curvature of the front portion of the predetermined thermal reading profile. Thereby, contrary to the normal crescent shape of MFM recording schemes and pit shapes of ROM media, the domain wall has the same shape as the thermal profile, so that the domain wall movement will start at the same time for all lateral positions in the track, which leads to reduced jitter and enables high density. Moreover, upon expansion, the length of the domain wall will not increase. Furthermore, the substrate may have an injection moulded ROM format.

In the manufacturing method, the surface structure of the substrate may be processed in the processing step. Thereby, different magnetizations of mark and space regions can be defined by the surface roughness or embossed structures. In particular, the substrate may be processed by an electron beam (e-beam) recording method. Such an e-beam recording method enables the formation of small structures required for high density writing in the storage layer of domain expansion media Other methods that induce a localized difference in the magnetic properties may be used as well to define the high resolution information structures.

Furthermore, the substrate may be processed by using a stamper obtained from an injection moulded master substrate. The master-substrate may be mastered by the e-beam recording method.

Thus, a domain expansion ROM medium with enhanced readout properties can be provided in a practically feasible manner.

In the following, the present invention will be described in greater detail on the basis of a preferred embodiment with reference to the accompanying drawings, in which:

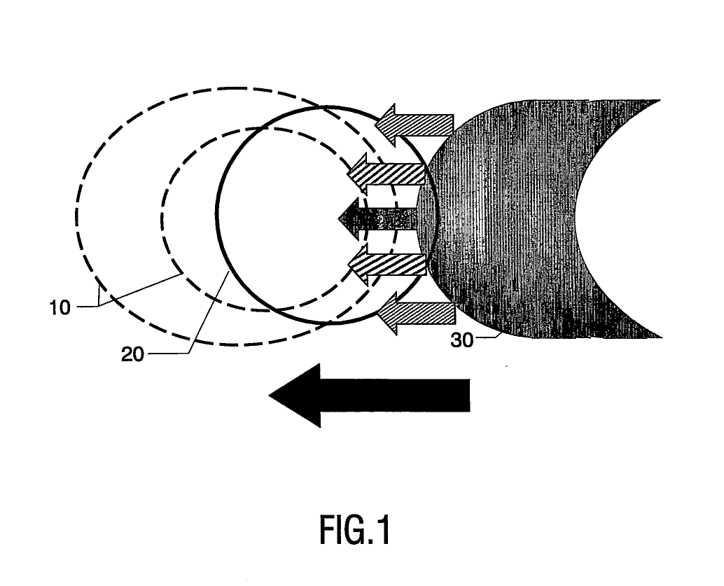

FIG. 1 shows a readout mechanism with normal MFM domains;

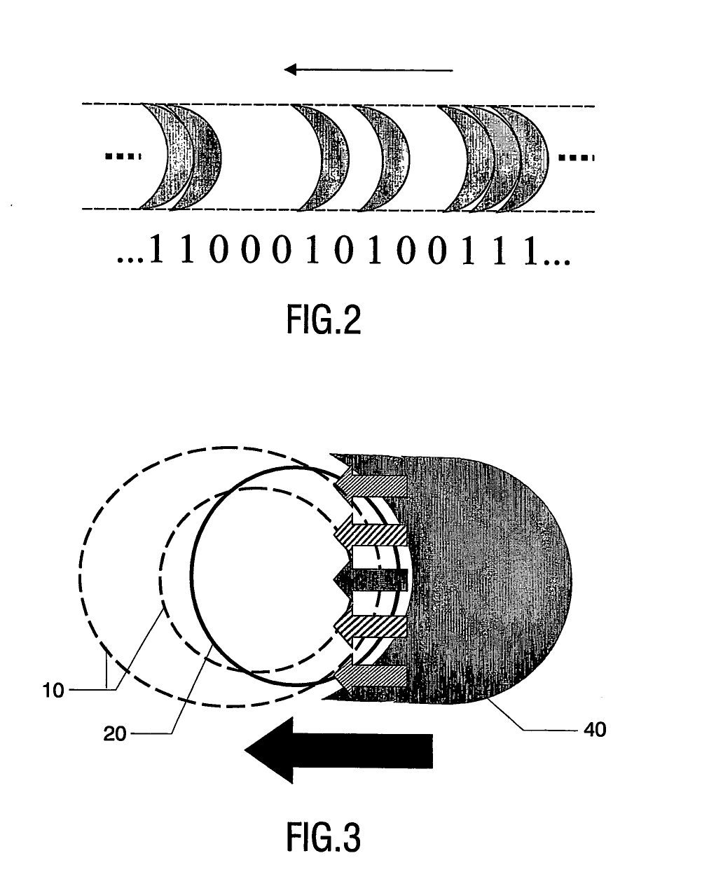

FIG. 2 shows a track portion with reversed MFM domains according to the preferred embodiment of the present invention;

FIG. 3 shows a readout mechanism with reversed crescent shaped domains according to the preferred embodiment; and

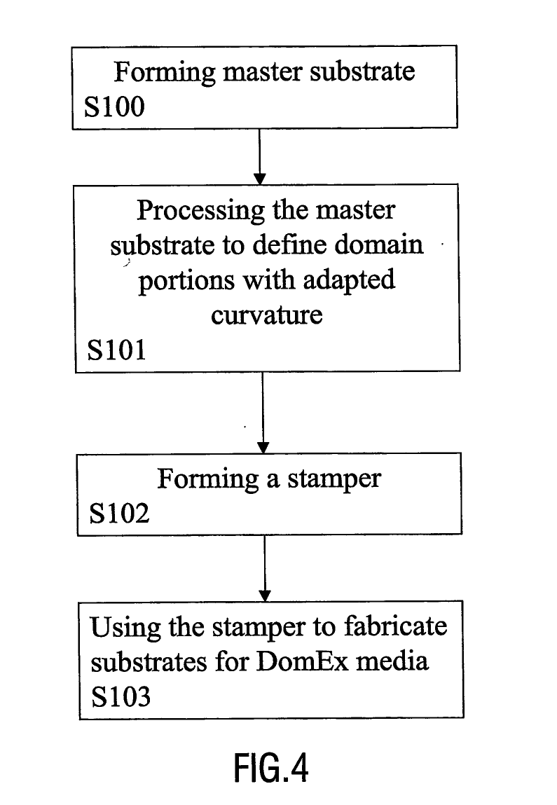

FIG. 4 shows a schematic flow diagram of a manufacturing method according to the preferred embodiment of the present invention.

The preferred embodiment will now be described on the basis of a domain expansion ROM disc, wherein an injection moulded ROM format which is mastered e.g. by an e-beam recording, is used to define crescent shaped domains with a shape similar to conventional LP-MFM recording.

FIG. 1 schematically illustrates a readout mechanism for normal crescent shaped domains 30, e.g. My domains, where the front curvature facing an optical reading reading spot 20 is not adapted to the temperature contour lines 10 of the temperature profile generated by the heating energy of the optical reading spot 20, e.g. radiation spot or laser spot. The black arrow indicates the disc movement direction which explains the spatial offset between the optical reading spot 20 and the temperature contour lines 10 of the temperature profile.

The smaller arrows at the front curvature of the left crescent shaped domain 30 indicate the domain wall movements in the readout layer due to the reduced coercivity generated by the temperature profile. As can be gathered from FIG. 1, the domain wall movements starts in the center of the track (dark grey arrow), as the central part of the front curvature of the normal crescent shaped domain 30 is heated first. The outer regions and edges of the track are heated later, so that their domain wall movements start later (as indicated by the hatched arrows). Due to this non-uniform heating process of the crescent shaped domain 30, a slow and irregular domain wall movement response is obtained which leads to jitter and lower densities. The fact that the length of the domain wall and thus the wall energy must increase during expansion, results in a reduced expansion speed and hence lower data rate.

Therefore, according to the preferred embodiment, it is proposed to record or write reversed crescent shaped domains, flipped in the track direction, such that the front curvature has a concave shape which matches with the temperature contour line of the temperature profile.

FIG. 2 shows a track portion with a predetermined pattern of such reversed crescent shaped domains, wherein the arrow indicates the movement direction of the ROM medium, e.g. ROM disc. In the lower part of FIG. 2, a binary information which may correspond to the above domain pattern is indicated.

FIG. 3 shows an improved readout mechanism obtained by using the reversed crescent shaped domains 40, e.g. reverse MFM domains, of the storage layer. As indicated in FIG. 3, the temperature contour lines 10 of the temperature profile generated by the optical reading spot 20 at least substantially match with the curvature of the concave shape of the front portion of a left copied reversed crescent shaped domain 50 of the readout layer, as copied from a corresponding domain 40 of the storage layer. In this way, the ROM format has the same benefits obtained by a reversed disc rotation, but without any of the practical difficulties of such systems. The preferred shape of the reversed crescent shaped domains 40 of the storage layer is selected such that the curvature of the concave front portion is very close to that of the thermal profile in the readout layer, i.e. the temperature contour lines 10 at the readout temperature. Thereby, the domain wall of the copied reversed crescent shaped domain 50 has the same shape as the temperature contour lines 10 so that domain wall movement in the readout layer will start at the same time for all lateral positions in the track, as indicated by the small arrows in FIG. 3, which are all located at the same longitudinal position of the track. This results in small jitter and enables high density writing. Moreover, upon expansion, the length of the domain wall will not increase, so that the wall energy does not increase and an easy and faster expansion with smaller timing jitter can be obtained compared to domains that do not have the above described preferred shape.

In general, the information may be pressed onto the substrate by injection moulding or by embossing a layer of photopolymer coated on a glass substrate. As an alternative, the information may be stamped onto or defined on the substrate itself. The magneto-optical recording medium or disc for realizing super-resolution or domain expansion reading may be composed of any magnetic layer or film differing in the coercive force depending on the recorded information and possessing a relatively large magneto-optical effect. The different magnetization direction of the reversed crescent shaped domains 40 may be defined by the surface state of the substrate, i.e., whether the surface of the substrate is a minute projection and/or recess surface or a smooth surface of a non-mark portion. This directly effects the crystal growth state of the film of the magnetic storage layer, and a film of different magnetic characteristics grows. The coercive force of the magnetic storage layer formed on a minute projection-recess surface tends to become greater than that of the magnetic layer formed on the smooth surface. This is due to the fact that the smoother surface of the substrate reduces the pinning force. It is thus possible to utilize the difference in the coercive force to magnetize a mark portion and a non-mark portion in opposite directions. That is, the information recorded on the substrate can be transferred as the information of the direction of magnetization to the storage layer. As an alternative, the recording information may be expressed by roughening the recording domain portion on the substrate, as compared with the other portion. The coercive force begins to increase when the mean dimension of the roughness of the surface in the in-plane direction becomes about 10 nm or more, and the coercive force begins to increase when the mean dimension of the roughness of the surface in the perpendicular direction becomes about 3 nm or more. Hence, depending on the recording information, when the RE-TM alloy magnetic storage layer is formed on the substrate having a portion with mean roughness of the surface in the in-plane direction and perpendicular direction of 10 nm or more and 3 nm or more, respectively, and a portion with mean roughness of the surface in the in-plane direction and perpendicular direction of 10 nm or less and 3 nm or less, respectively, a magneto-optical recording medium possessing portions differing in the coercive force depending on the recording information is obtained. Further details regarding such a writing scheme can be obtained from the U.S. Pat. No. 5,993,937.

As a further alternative, the storage layer may be directly processed by any method suitable to locally modify the magnetic properties of the storage layer so as to define the reversed crescent shaped domains 40, e.g. reverse MFM domains, of the storage layer.

In the following, a method of manufacturing such a domain expansion ROM disc is described with reference to the flow diagram of FIG. 4. According to FIG. 4, a master substrate is formed by injection moulding. Then, the master substrate is processed to define domain portions with adapted curvature, e.g. reversed crescent shaped domain portions as indicated in FIG. 2 (step S101). The corresponding processing of the master substrate may be a surface processing as indicated in the above examples. The mastering process of the master substrate may be obtained e.g. by an e-beam recording so as to define in the magnetic storage layer reversed crescent shape domains similar to conventional LP-MFM recording but flipped in the track direction to obtain the adapted curvature. However, other suitable processing schemes such as ion etching, ion beam lithography or the like may be used as well for processing the master substrate. In step S102 of FIG. 4, a stamper is formed by using the master substrate. This stamper is then used in step S103 to fabricate or manufacture substrates for the domain expansion media This fabrication may be based on an injection method or the like. Thus, the substrate can be fabricated easily by mass duplication methods of conventional substrates by using a master substrate with processed surface portions corresponding to the recording information. It is to be noted that steps S101 and S102 of FIG. 4 may be changed in such a manner, that the stamper is first formed in step S101 and is then processed in step S102 to define domain portions with adapted curvature. In this case, the recording information is written on the stamper and not on the master substrate.

As a further alternative, the substrate of each individual ROM disc may be directly processed without using a stamper to define the domain portions with adapted curvature.

The magnetic storage and readout layers may be composed of any RE-TM compound having relatively high magneto-optical effects, such as TbFe, GdTbFe, TbFeCo, GdFe, GdFeCo, DyFe, GdDyFe, DyFeCo, GdDyFeCo, and NdTbFeCo, or a transition metal oxide and nitride compound film, a ferrite film, or a 3d transition metal magnetic film, or e.g. Co/Pt or Co/Pd multilayers or combinations with RE-TM layers.

The present invention can be applied to any domain expansion ROM medium, while any suitable processing of the substrate or magnetic storage layer can be used to define the proposed domain portions with adapted curvature. Furthermore, any domain shape having a front curvature adapted to the thermal reading profile can be used. The preferred embodiment may thus vary within the scope of the attached claims.

1. A domain expansion storage medium in which a magnetic wall is displaced to thereby enlarge a magnetic domain in a readout layer so as to reproduce an information indicated by a magnetic domain in a storage layer, wherein a substrate of said storage medium has a locally modified surface structure or said storage layer has a locally modified magnetic property, arranged to define a predetermined shape of said magnetic domain, said predetermined shape having a curvature adapted to a predetermined thermal reading profile.

2. A storage medium according to claim 1, wherein said magnetic domain has a crescent shape reversed with respect to a rotation direction of said storage medium, the curvature of the concave edge of said crescent shape substantially matching with the facing curvature of said predetermined thermal reading profile.

3. A medium according to claim 1 or 2, wherein said substrate has an injection moulded format.

4. A storage medium according to claim 1, wherein said storage medium is a MAMMOS disc or a DWDD disc.

5. A method of manufacturing a domain expansion storage medium, in which a magnetic wall is displaced to thereby enlarge a magnetic domain in a readout layer so as to reproduce an information indicated by a magnetic domain in a storage layer, said method comprising the step of locally processing the surface structure of a substrate of said storage medium or the magnetic properties of said storage layer so as to define a predetermined shape of said magnetic domain, said predetermined shape having a curvature adapted to a predetermined thermal reading profile.

6. A method according to claim 5, wherein said magnetic domain is defined with a crescent shape reversed with respect to a rotation direction of said storage medium, so that the curvature of the concave edge of said crescent shape substantially matches with the facing curvature of said thermal reading profile.

7. A method according to claim 5, wherein the surface structure of said substrate is processed in said processing step.

8. A method according to claim 5, wherein said substrate is processed by an electron beam recording method or a recording method adapted to induce a localized difference in said magnetic properties.

9. A method according to claim 5, wherein said substrate is processed by using a stamper obtained from an injection moulded master substrate.

10. A method according to claim 9, wherein said master substrate is mastered by an e-beam recording method.
